(19) United States
(12) Patent Application Publication
(10) Pub. No.: US 2018/0238588 A1
(43) Pub. Date: Aug. 23, 2018

(54) Water heater solar panel with collector, heat exchanger and storage tank of water manufacturate with polyimers

(71) Applicant: Eduardo Cubillo Losada, Alpedrete (ES)

(72) Inventor: Eduardo Cubillo Losada, Alpedrete (ES)

(21) Appl. No.: 12/658,634

(22) Filed: Apr. 9, 2010

(51) Int. Cl. F24S 10/70; F24S 10/50

(52) U.S. Cl. CPC F24S 10/70; F24S 10/50

(57) ABSTRACT

Water heater solar panel with collector heat exchanger and storage tank of water manufactured with plastic materials. This solar panel for heating water is manufactured with expanded polystyrene foam, glasses, a metal sheet and some plastic fittings. The collector of sun and water storage tank are assembled together, allowing the transfer of heat from the primary circuit to the secondary circuit without tubes, through a heat exchanger consisting of a metal sheet. The storage tank is integrated in the collector so that improves handling and lowers the cost in fluid transport and the manufacture of it. The weight of this panel is distributed regularly on the roof or deck.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

The current solar collectors for domestic hot water at low temperatures of this type of solar panel with two circuits, comprises of a collector panel with tubes, usually copper, that carry the coolant to an accumulator. This tank has a coil or heat exchanger inside that heats the water in the secondary circuit. The primary water transport is done by the accumulator thermo siphon which is above the collector. When the storage tank is in another room, the fluid is transported by a pump. In general, basically consist of three elements, collector, storage tank and concessions liaison with or without pump. In addition, their collectors are manufactured primarily with metallic materials, glass fiber or glass wool insulation.

### BRIEF SUMMARY OF THE INVENTION

This solar panel combines the solar collector, the storage tank of hot water and the heat exchanger, in one piece. The sun collector and the water storage tank are together; a thin metal sheet separates the two circuits. The collector is a glass that captures the sun's rays. The sun's rays bounce off the black surface of the wall of the chamber turning light into heat. This heat warms the primary circuit coolant that fills the outer chamber. When the liquid temperature rises, it increases pressure and causes the valve to open allowing fluid to pass to the inner chamber where it contacts the heat exchanger that heats the secondary circuit water. As the coolant cools down, it descends through the inner chamber returning back to the outer chamber through the bottom valves. Once it is exposed to the sunlight, it heats back up ascending through the chamber causing the fluid to flow and closing the circuit.

On the other side of the thin metal sheet is the storage tank of hot water. The cold water enters the bottom of the water tank. The water is bound to go a long way in a zigzag allowing greater exchange of energy between the two circuits. The design of the walls allows the hot water to rise to the top of the water tank to a more isolated compartment where it exits at the top for consumption or use. The arrangement of the valves allows only for one direction in flow, so when the Sun ceases, the inner chamber of the primary circuit is isolated. The water heater is built with plastic materials, glass, and a sheet of metal.

The water tank housing and the walls of the primary circuit chambers are made of expanded polystyrene foam.

### BRIEF DESCRIPTION OF THE SEVERAL VIEWS OF THE DRAWINGS

The patent or application file contains at least one drawing executed in color. Copies of this patent application publication with color drawings will be provide by the Office upon request and payment of the necessary fee.

FIG. 1. Panel components.

FIG. 2. Upper and lower section details.

FIG. 3. Longitudinal section shows the right side of the full longitudinal section.

FIG. 4. Solar panel assembly shows exploded view containing all of the components belonging to the solar panel for assembly purposes.

FIG. 5. Dynamic of fluids (A) shows the distribution of the fluids in the full longitudinal section of the solar panel.

FIG. 6. Dynamic of fluids (B) shows the functional modes of valves during periods with and without Sun.

FIG. 7. Solar panel assembled shows a general X-ray view of the solar panel.

FIG. 8. Solar panel with coolant circulation pump.

FIG. 9. Installation diagram shows a likely solar panel installation.

FIG. 10. Diagram.

### DETAILED DESCRIPTION OF THE INVENTION

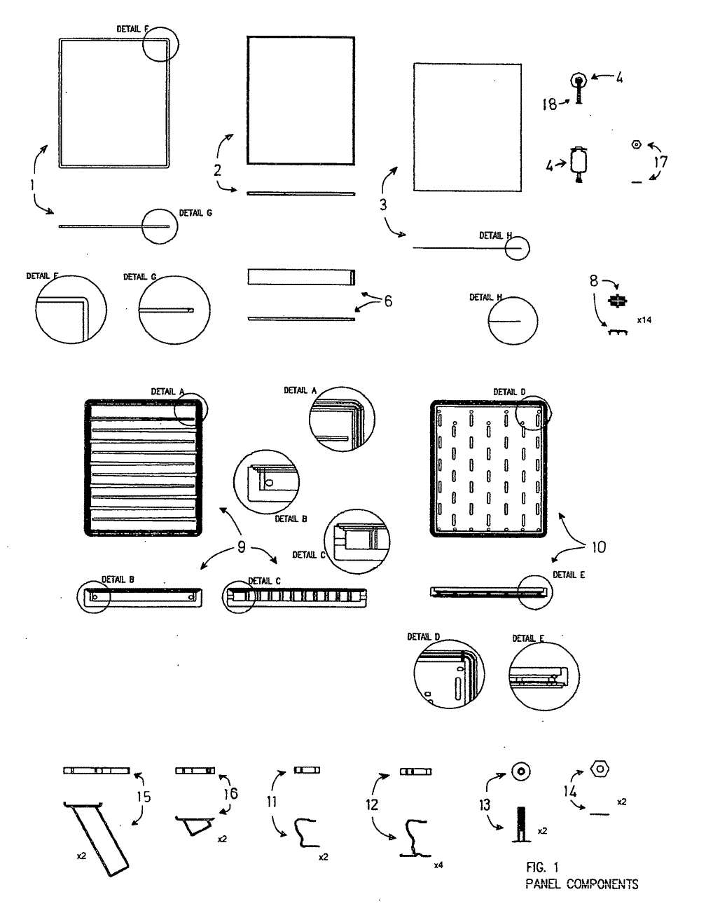

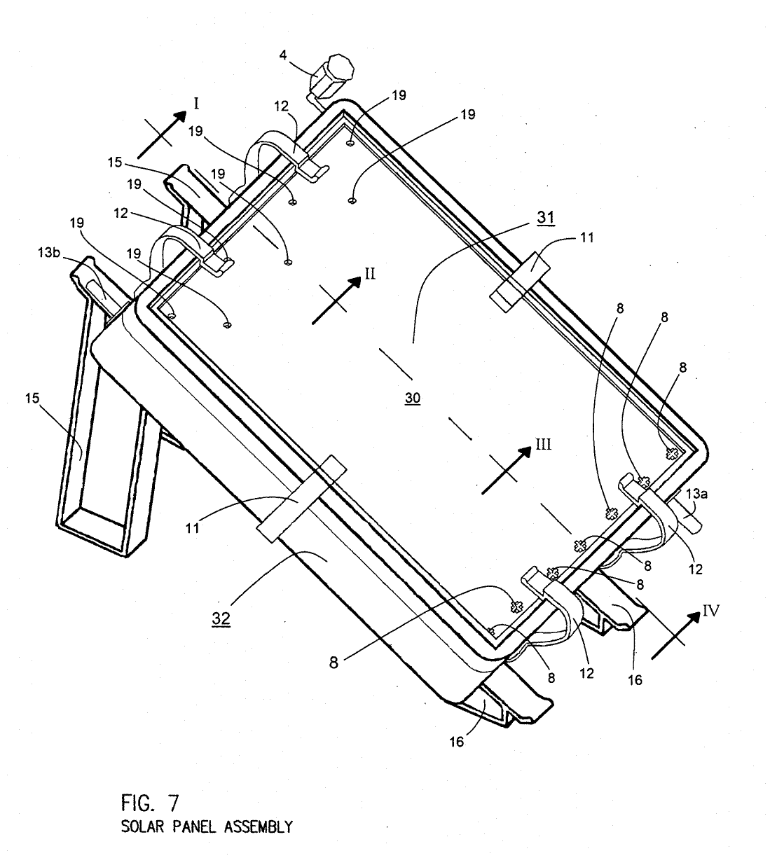

In FIG. 1, Panel components shows each one of the components of the solar panel 30 FIG. 7 drawing in orthographic view for a standard model: top frame 1, glass 2, metal sheet 3, filling/expansion tank 4, filling/expansion tank fitting 18, filling/expansion tank fitting nut 17, storage tank top 6, valves 8, base housing 9, middle housing 10, side clips 11, anchorage clips 12, large floor anchors 15, short floor anchors 16, inlet fitting 13, inlet fitting nut 14.

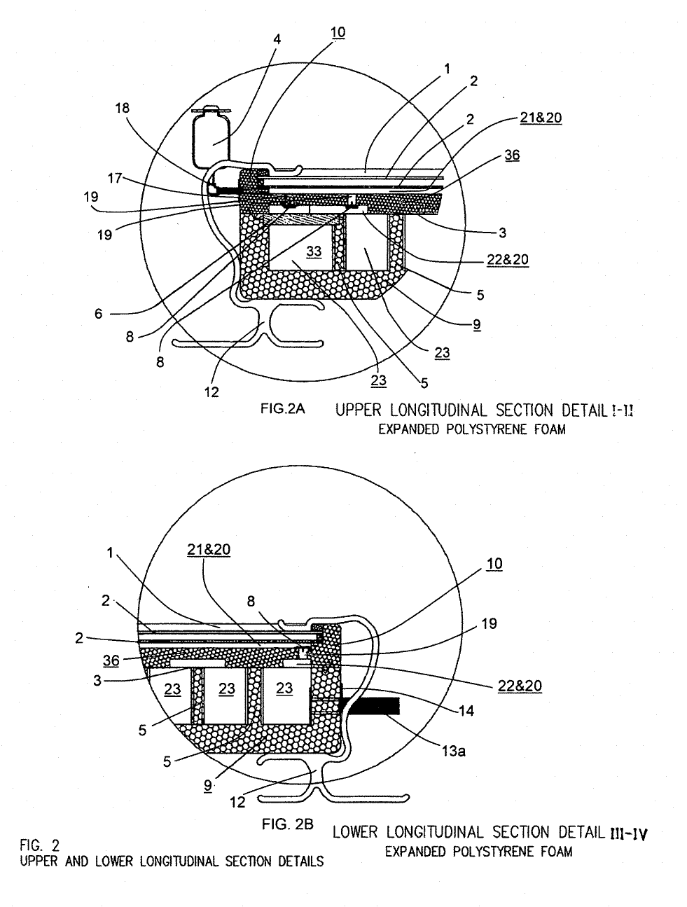

In FIG. 2, Upper and lower section details:

In the upper or first panel end longitudinal section detail along line I-II on FIG. 2A shows:

How the storage tank top 6 is installed shape the hot water tank 33.

The location of the filling/expansion tank 4 in the outer chamber 21 of the primary circuit 20. The filling/expansion tank 4 is mounted by the filling/expansion tank fitting 18, plus nut, 17 in the middle housing perimeter wall.

The position of the holes 19 in the partition wall 36 of the middle housing 10 and the position of the valves 8 placed in the inner chamber 22 of the primary circuit 20.

In the lower or second panel end longitudinal section detail along line III-IV on FIG. 2B shows:

The location of the inlet fitting 13a of cold water 25 mounted in the base housing perimeter wall, plus nut 14.

The position of the holes 19 in the partition wall 36 of the middle housing 10 and the position of the valves 8 placed in the outer camber 21 of the primary circuit 20.

In both details shows:

The primary 20 and secondary 23 circuits.

The inner chamber 22 and the outer chamber 21 of the primary circuit 20 separated by the partition wall 36 of the middle housing.

The separation of primary circuit 20 and secondary circuit 23 via a metal sheet 3, (exchange heater) 35.

The primary circuit 20 is bounded by the glass 2, middle housing 10 and the metal sheet 3.

The secondary circuit 23 is bounded by the metal sheet 3 and the base housing 9.

Interior walls 5 of storage tank of the base housing 9.

Base housing 9, metal sheet 3, middle housing 10, glass 2, top frame 1, clamped by the anchorage clips 12.

In this standard model the base housing 9, middle housing 10, storage tank top 6 and the top frame 1 are all produced from expanded polystyrene foam.

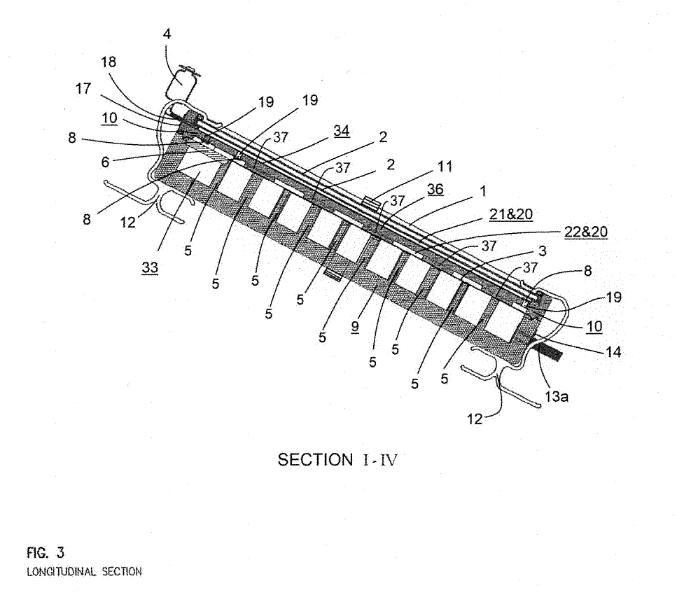

In FIG. 3, Longitudinal section shows the right side of the full longitudinal section along line I-IV indicating:

The holes 19 in the expanded polystyrene foam connecting the inner chamber 22 and the outer chamber 21 of the primary circuit 20 through the partition wall 36 of the middle housing 10.

The position of the upper valves 8 in the first panel end 30 FIG. 7 in the inner chamber 22 and the lower one's 8 in the second panel end 30 FIG. 7 in the outer chamber at the holes 19 in partition wall 36 of the middle housing 10.

The primary circuit 20 is bounded by the glass 2 and the metal sheet 3.

The separation of the outer chamber 21 and the inner chamber 22 of the primary circuit 20 via partition wall 36 of the middle housing 10.

The separation of the inner chamber 22 of the primary circuit 20 and the secondary circuit 23 via metal sheet 3.

The metal sheet held on one side by the walls 5 of the base housing 9 and on the other side with the buttresses 27 of the middle housing 10.

Interior walls 5 of storage tank 32 FIG. 7 at the base housing 9 forming the secondary circuit travel channels 26 and the hot water tank 33 at the first panel end.

The anchorage clips 12 and side clips 11.

Additionally is visible the black surface 35 at the outer surface of partition wall 36 of the middle housing 10 of outer chamber 21.

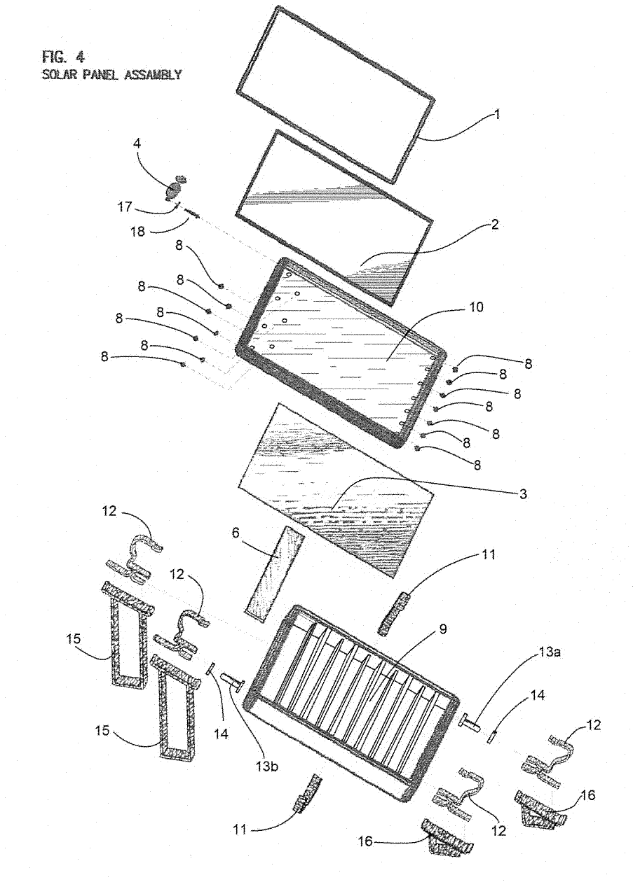

In FIG. 4, Solar panel assembly shows exploded view containing all of the components belonging to the solar panel 30 FIG. 7 for assembly purposes in order:

Frame top 1 and glass 2 over middle housing 10.

Attach valves 8 to the corresponding side of the partition wall 36 and filling/expansion tank 4 components to the middle housing 10.

Metal sheet 3 between middle housing 10 and base housing 9.

The storage tank top 6, inlet and outlet fittings 13b & 13a, to the base housing 9.

Place vertically in order, over the base housing 9, each one over the other components.

Clips 11 and anchorage clips 12 positioned creating a solar panel block 30 FIG. 7.

Once created the solar panel block 30 FIG. 7, mounting can be via the floor anchor 15 and 16 or directly via anchorage clips 12 on the pitched roof.

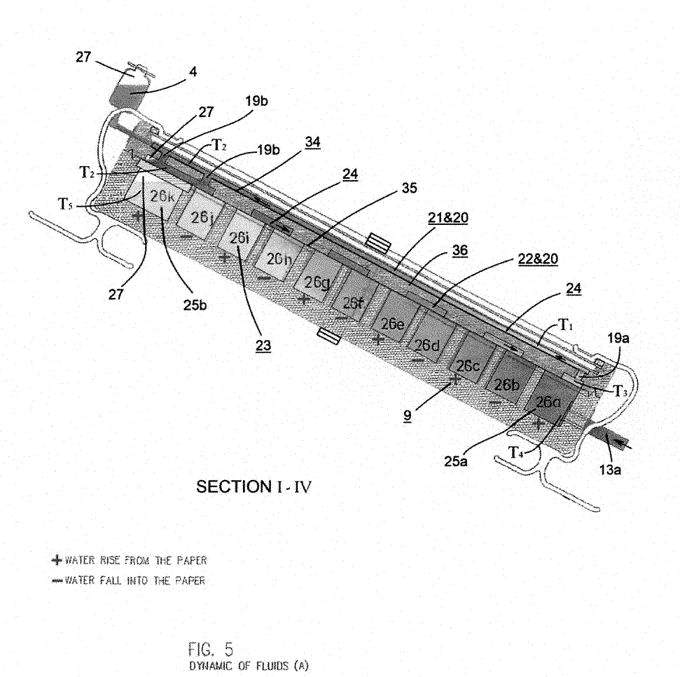

In FIG. 5, Dynamic of fluids (A) shows:

The distribution of the fluids in the full longitudinal section along line I-IV of the solar panel 30 FIG. 7. In the primary circuit 20 FIGS. 2,3,5&10 is represented by the range of colors from orange yellow to red and the secondary circuit 23 FIGS. 2,3,5&10 by the range of colors of blue, green and yellow understanding that the temperature is higher when the color is warmer.

The primary fluid or coolant 24 in the primary circuit 20 and water 25 in secondary circuit 23. The colors represent an intuitive idea of the temperature of the fluids in one instance.

During sunny periods the primary circuit coolant 24 at temperature T₁ rises though the outer chamber 21, flows through the first panel end holes 19b of the partition wall 36 at temperature T₂ higher than T₁ and falls through the inner chamber 22 losing heat through the heat exchanger lowering the temperature at T₃ lower than T₂ passing through the second panel end holes 19a of the partition wall 36 into the outer chamber 21 where the cycle begins again when the first panel end is above se second panel end and the outer chamber 21 is exposed at sun.

Non sunny periods the cycle remains interrupted by the valves 8.

In the secondary circuit 23, the cold water 25a enters through the inlet fitting 13a at temperature T₄ and commences a zigzag movement between the walls 5 of the channels within the base housing 9 until reaching the upper side. When the water 25 enters the first lower channel 26a the water 25 rises from the paper until the end of the channel 26a, passing to the second channel 26b in the opposite direction into the paper to the end of the channel where the water 25 passes to the third channel 26c where it rises from the paper again and so on till it reaches the upper side at temperature T₅ higher than T₄, where the water 25 exits through the hot water outlet fitting 13b.

As such, the water 25 that looses temperature starts to fall through the same path towards the bottom of the solar panel 30.

It's visible to see pockets of air 27 trapped in the secondary 23 and primary 20 circuits, plus the filling/expansion tank 4.

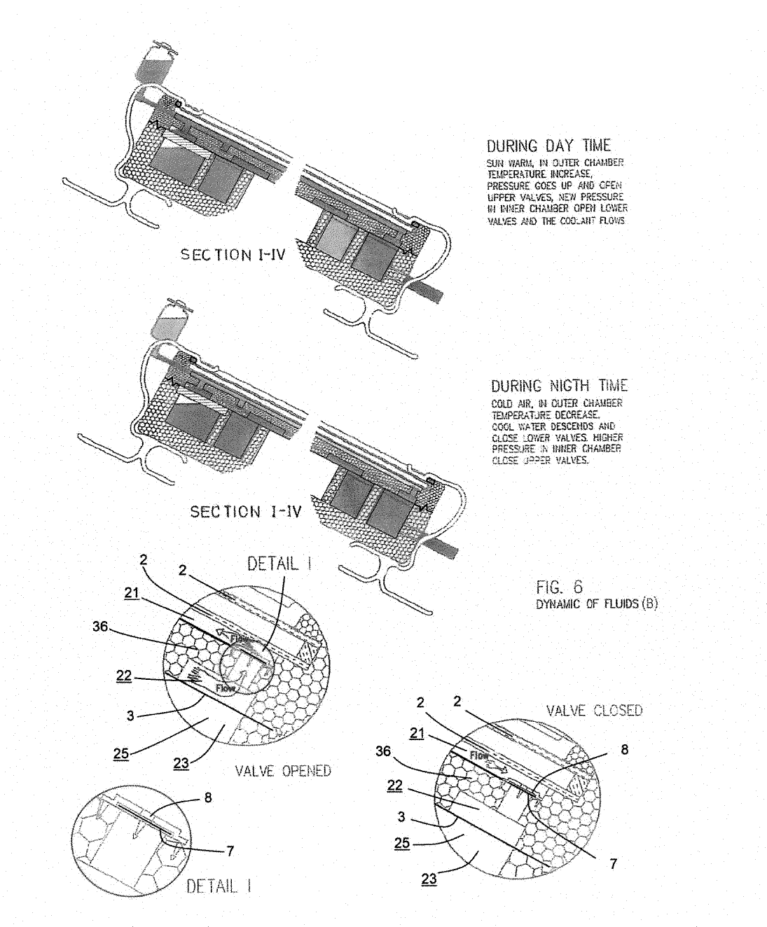

In FIG. 6, Dynamic of fluids (B) shows:

Colors during the nighttime are less warm than during the daytime.

The functional modes of valves 8 during periods with and without Sun.

In the lower details, you can see how the valves 8 open and close depending on the direction of coolant 24 flow. During daytime Sun, warn in outer chamber 21 temperature increase, pressure goes up pushing the membrane 7 and open upper valves 8, new pressure in inner chamber 22 open lower valves 8 and the coolant 24 flows. During nighttime cold air, in outer chamber temperature decrease, cold coolant 24 descends pushing the membrane 7 and close lower valves 8, higher pressure in inner chamber close upper valves 8.

In FIG. 7, Solar panel 30 assembled shows:

A general view of the solar panel 30 where you can see two main parts, the solar collector 31 and the storage tank 32.

The solar collector is former by top frame 1, glasses 2, middle housing 10 with valves 8 and filling/expansion tank with components 4 and metal sheet 3 as heat exchanger 35.

The storage tank 32 is former by base housing 9, inlet and outlet fitting 13a & 13b, storage tank top 6 and sharing metal sheet 3 with the solar collector 31.

As well, lines of section I-II, III-IV and I-IV.

As well, inlet 13a and outlet 13b fittings of water also the location of the filling/expansion tank 4.

The holes 19 in the first panel end at the partition wall 36 of the middle housing 10 and the position of the second panel end valves 8 in the outer side.

The clips 11 &12 and the attachment of the floor anchors 15 & 16.

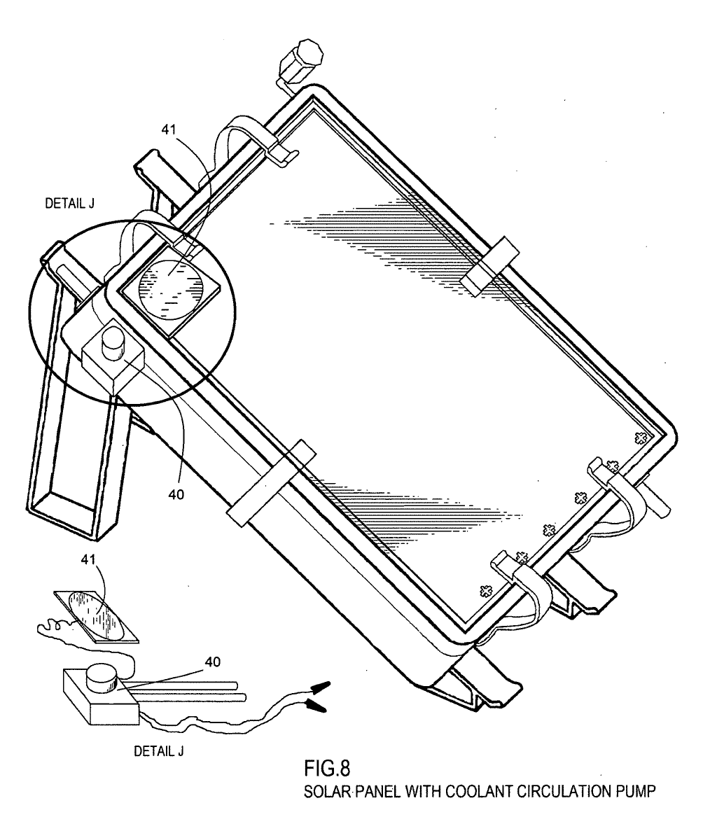

In FIG. 8, Solar panel 30 with coolant circulation pump 40 shows:

The location of the photovoltaic water pump 40 and the photovoltaic cell 41 in the solar panel 30. It's function is to pump the coolant 24 from the outer chamber 21 to the inner chamber 22 when the outer chamber temperature is higher than the inner chamber in the primary circuit 20.

In the lower part of the drawing there is a photovoltaic detailed. The pump 40 is electrical fed which is triggered by the control unit. The control unit switches on and off the pump 40 depending on the temperature reading in the temperature probes.

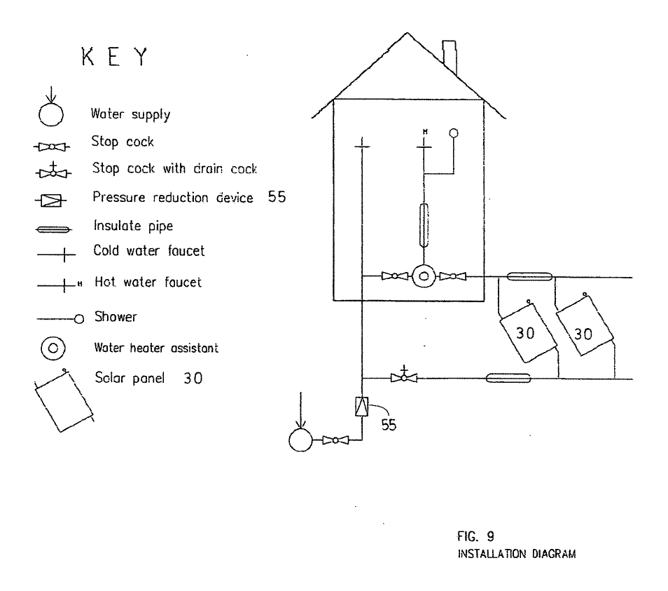

In FIG. 9, Installation diagram shows:

A likely solar panel 30 installation.

The water comes from the main water supply passes through the stopcock and the pressure reduction device 55 before entering the solar panel 30. Once heated, the water travels via an isolation pipe and enters the building for use. Then passes through a water heater assistant which is employed during night or winter periods.

In the water circuit, before the pressure reduction device 55 there is a stopcock with drain cock to aid with system drainage when required.

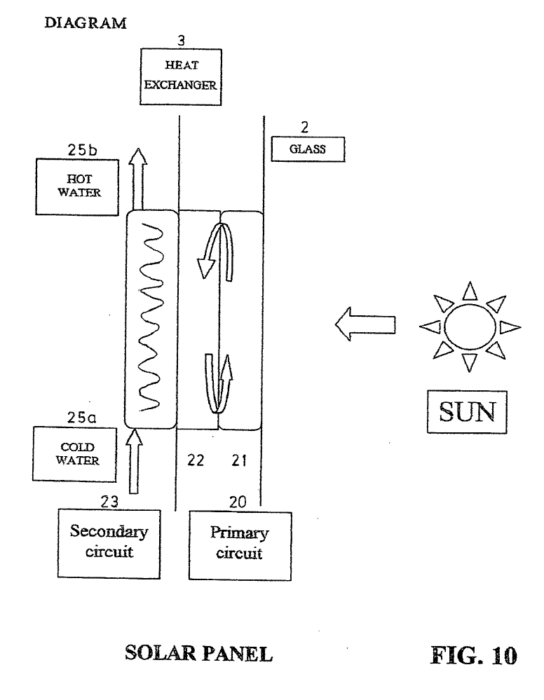

In FIG. 10, Diagram. Explanation of diagram FIG 10.

When the first panel end is above the second panel end and the sun's rays penetrate into the solar panel 30 FIGS. 7&8 through the glass 2 FIGS. 1,2,3,4,6 &10. light rays are transformed into heat, raising the pressure and coolant's temperature from T₁ to T₂ driving it up through the inner chamber 22 FIGS. 2,3,5,6 &10 of the primary circuit 20 FIGS. 2,3,5,6 &10 through the holes 19 FIGS. 2,3,5,&7 at the first panel end side of the partition wall. In the inner chamber 22 FIGS. 2,3, 5,6 &10 the coolant temperature decreases to T₃ transferring its heat to the cold water 25 FIGS. 5,6&10 in the secondary circuit 23 FIGS. 2,3,5,6,&10 through the heat exchanger 35 FIG. 5 (metal sheet 3 FIGS. 1,2,3,4,6 &10). Then the coolant 24 FIG. 5 cools down at a temperature T₃ and descends to the outer chamber 21 FIGS. 2,3,5,6 &10 through the holes 19 FIGS. 2,3,5,&7 in the second panel end side of separation wall 36 from the inner chamber. There the coolant 24 FIG. 5 is heated again by the Sun and rises to restart the cycle.

In the secondary circuit 23 FIGS. 2,3,5,6&10 cold water 25a FIGS. 5,6&10 enters the bottom at second panel end of the storage tank at a temperature of T₄ where it's forced to travel a long way to the top of the storage tank. In this route the water 25 FIGS. 5,6&10 is in contact with the heat exchanger 35 FIG. 5, (metal sheet 3 FIGS. 1,2,3,4,6 &10) capturing heat from the primary circuit 20 FIGS. 2,3,5,6&10 so when the water 25a FIGS. 5,6&10 comes from the top it is hot 25b FIGS. 5,6&10 at a temperature of T₅ higher than T₄.

Solar panel 30 FIGS. 7 & 8 with collector 31 FIG. 7 for low temperature warm sanitary water with heat exchanger 35 FIG. 5, (metal sheet 3 FIGS. 1,2,3,4,6 &10) and storage tank 32 FIG. 7 of warm water 25b FIGS. 5,6 &10 incorporated is manufactured with plastics (expanded polystyrene foam, FIG. 2 or obstructed polystyrene, or sindiotatic polystyrene), sheet metal 3 FIGS. 1,2,3,4,6 &10 (aluminum, or copper, or stainless steel; chosen according to market price) as heat exchanger 35 FIGS. 5 & 10, double glass (glass space glass) 2 FIGS. 1,2,3,4,6 &10 or only one glass depending on the model, black paint 34 FIGS. 3&5 or absorbent material of solar radiation on the surface of the outer chamber 21 FIGS. 2,3,5,6 &10 of primary circuit 20 FIGS. 2,3,5,6 &10. Valves 8 FIGS. 1,2,3,4,6&7, clips 11 FIGS. 1,3, 4 &7 or anchor clips 12 FIGS. 1,2,3, 4&7, are made of Polyvinylchloride (PVC). The connection fittings 13 FIGS. 1,2,3,4,5,&7 to the secondary circuit 23, FIGS. 2,3,5,6&10 nuts 14 FIGS. 1,2,3&4, washers and filling/expansion tank 4 FIGS. 1,2,3,4,5,&7 shall be made of polyethylene.

This panel 30 FIGS. 7&8 is composed of a base housing 9 FIGS. 1,2,3,4&5 used to store hot water 32 FIGS. 7 & 33 FIG. 2,3 of the secondary circuit 23 FIGS. 2,3,5,6&10. This hot water is heated with a heat exchanger 35 FIG. 5 consisting in a thin metal sheet 3 FIGS. 1,2,3,4,6 &10 placed between the base housing 9 FIGS. 1,2,3,4 & 5 and the middle housing 10 FIGS. 1,2,3,4& 5 held by the walls 5 FIGS. 2&3. of the base housing and the buttresses 37 FIG. 3 of the middle housing 10 FIGS. 1,2,3,4& 5. This warm water storage tank 32 FIG. 7 has a small compartment on the first panel end 33 FIGS. 2&3 that maintains a portion of better isolated water. Cold water 25a FIGS. 5 &10 enters through an inlet fitting 13a FIGS. 1,2,3,4,5&7 at the bottom or second panel end of the base housing 9 FIGS. 1,2,3,4&5 and is forced to follow a way in a zig-zag between walls 5 FIGS. 2&3 forming channels within the storage tank 32 FIG. 7 to increase its contact with the heat exchanger 35 FIGS. 5&10. The interior walls 5 FIGS. 2&3 layout of the base housing 9 FIGS. 1,2,3,4&5 gives stiffness, allows the water in the tank rise by convection to the upper channel where it is better isolated when there is no consumption and also ensures the metal sheet to coincide on the other side with the buttresses 37 FIG. 3 of the middle housing 10 FIGS. 1,2,3,4 &5.

The middle housing is designed to hold the metal sheet 3 FIGS. 1,2,3,4, 6 &10 (heat exchanger 35 FIGS. 5&10) inside and the glass 2 FIGS. 1,2,3,4,6 &10 outside. This middle housing 10 FIGSS. 1,2,3,4 & 5 forms the two chambers 21&22 FIGS. 2,3,5,6 &10 of the primary circuit 20 FIGS. 2,3,5, 6 & 10 by means of the partition wall 36 FIGS. 2,3,5 &6. The inner chamber 22 FIGS. 2,3,5,6 &10 is bounded by the metal sheet heat exchanger 35 FIGS. 5,&10, and the inner partition wall surface and its periphery perpendicular walls of the middle housing 10 FIGS. 1,2,3,4 & 5.

The outer chamber 21 FIGS. 2,3,5,6&10, with its outer partition wall surface painted or colored of black color or with a film of solar radiation absorbent material 34 FIGS. 3&5, is placed at the opposite side of the inner chamber 22 FIGS. 2,3,5,6&10. The outer chamber 21 FIGS. 2,3,5,6&10 is bounded by the outer partition wall surface and its periphery perpendicular walls of the middle housing 10 FIGS. 1,2,3&4 & 5-and the glass 2 FIGS. 1,2 3,4,6 &10 which is held and pasted with a framework or top frame 1 FIGS. 1,2,3&4. The entire panel 30 FIGS. 7&8 as a sheet or “sandwich” composed of base housing 9 FIGS. 1,2,3,4&5 with inlet 13a and outlet 13b fittings 13 FIGS. 1,2,3,4,5&7, sheet metal 3 FIGS. 1,2,3,4 &6, the middle housing 10 FIGS. 1,2,3,4 & 5, with the valves 8 FIGS. 1 2,3,4,6 & 7, and filling/expand tank 4 FIGS. 1,2 3,4,5, &7 the sheets of glass 2 FIGS. 1,2,3,4,6&10 and frame 1 FIGS. 1,2,3&4 are fastened and attached by clips 11 FIGS. 1,3,4&7 and 12 FIGS. 1,2,3,4&7. The two upper clips at the first panel end and the two lower clips at the second panel end 12 FIGS. 1,2,3,4 &7 designed so that they can be anchored to the structures of flat 15 &16 FIGS. 1&7 or tilted roofs. The middle housing 10 FIGS. 1,2,3,4 & 5 has holes 19 FIGS. 2,3,5&7 in the partition wall 36 FIGS. 2,3,5 &6 through which coolant 24 FIG. 5 (water or glycol or mixtures or water with salt, etc . . . ) circulates from one chamber to another of the primary circuit 21 FIGS. 2,3,5,6&10. This movement occurs by convection when the fluid is heated by sun exposure FIG. 10 in the outer chamber 21 FIGS. 2,3,5,6&10. The coolant fluid 24 FIG. 5 of this chamber warmed by the Sun and the help of the black color of the surface 34 FIGS. 3 &5 causes the opening of the valves 8 FIGS. 1,2,3,4,6 &7 by thermo siphon and flows to the inner chamber 22 FIGS. 2,3,5,6 &10 to enter in contact with the heat exchanger 3 FIGS. 1,2,3,4&10. This circulation of fluid in the primary circuit 20 FIGS. 2,3,5,6&10 can also be enforced with a small pump 40 FIG. 8 powered by a photovoltaic cell 41 FIG. 8 when the latitude does not allow the desired inclination of the panel 30 FIGS. 7&8.

The valves 8 FIGS. 1,2,3,4,6&7 with their membranes 7 FIG. 6 arrangement prevent recoil of fluid to the outer chamber 21 FIGS. 2,3,5,6&10 when the source of heat disappears, not allowing the fluid of the inner chamber 22 FIGS. 2,3,5,6&10 to get cold.

The primary circuit 22 FIGS. 2,3,5,6&10 is filled on top at the first panel end with the filling tank 4 FIGS. 1,2,3,4,5&7 that can also serve as expansion tank. Both the primary 20 and secondary 23 circuits FIGS. 2,3,5,6&10 retain small air pockets 27 FIG. 5 when being filled up to absorb liquids dilation.

A pressure reduction device 55 FIG. 9 can be placed before the cold water inlet 13 FIGS. 1,2,3,4,5&7 in the secondary circuit 23 FIGS. 2,3,5,6&10 to prevent overload.

Use rubber joints to prevent leakage, and glue or welding for more solidity.

The panel 30 FIGS. 7&8 will be oriented with its glazed surface to the Sun to obtain maximum lighting and performance; also with enough sloping so the fluid open the valves 8. FIGS. 1,2,3,4,6 &7 by thermo siphon for circulation.

This solar panel 30 FIGS. 7&8 is easy to manufacture consisting in four large molds, other small ones for minor pieces and a small production line for assembling.

They are also more economical and ecological than current models.

The size and thickness of the walls of the panel 30 FIGS. 7&8 can be variable according to model and climate. The weight of the panel 30 FIGS. 7&8 in operation and mount anchorages 15 and 16 FIGS. 1,4& 7 should be around 100 kg per square meter, matching the weight of the panel 30 FIGS. 7&8 with the usage load of the cover on households of each country. You can build larger models if the deck is built to support extra weight.

The outer surface of the panel 30 FIGS. 7& 8 may be painted to match the different types of cover (red tile, black slate, etc . . . ), and with UV filters if necessary.

1. The solar water heater panel comprising of two circuits:
A primary circuit for a coolant or low volatility fluid composed of two chambers connected in series by holes in the partition wall.
The first, a diaphanous outer chamber bounding by:
A glass sheet comprised of an upper surface in the part exposed to the sun and the lower one at the other side;
Outer surface of the partition wall of the middle housing;
A perpendicular top wall extending from the entire perimeter outer surface of the partition wall of the middle housing abutting until reaches the entire perimeter of lower surface of the glass sheet allowing sufficient space to hold and move the primary fluid or coolant.
A diaphanous outer chamber long enough for the density difference of the fluid primary or coolant at the first end above the second end of the outer chamber when the sun heats it, opens the valves and allows it to move.
The second, an inner chamber bounding by:
A sheet of metal, (heat exchanger), comprised of primary circuit surface and a secondary circuit one;
Inner surface of the partition wall of the middle housing;
A perpendicular top wall extending from the entire perimeter inner surface of the partition wall of the middle housing abutting until reaches the entire perimeter of primary circuit surface of the metal sheet, allowing enough space to hold and move the primary fluid or coolant.
The inner and outer chambers of the continuous primary coolant circuit being in sufficient fluid communication to support continuous circulation of coolant between the inner and outer chambers;
A secondary circuit is formed by a water storage tank connecting a cold water inlet through the inlet fitting at the second end of the panel to a hot water outlet through the outlet fitting at the first end of the panel.
The storage tank of the secondary water circuit bounded by:
A wall of the base housing comprised of an inner upper surface and an outer bottom surface;
A perpendicular top wall extending from the entire perimeter inner upper surface of the base housing abutting until reaches the entire perimeter of secondary circuit surface of the metal sheet;
A secondary circuit surface of the metal sheet closing the storage tank tightly allowing enough space to hold the secondary fluid as water.
The secondary and primary circuit is connected one to each side of the metal sheet, whose function is to facilitate the diffusion of heat between both circuits.
Whereby, the solar panel is configured to:
collect solar radiation and heat coolant from temperature T₁ to T₂ in the outer chamber;
establish a continuous flow of heated coolant leaving the outer chamber and entering the inner chamber of the primary circuit; and
transmit heat from the heated coolant in the inner chamber of the primary coolant circuit via the metal sheet to the water of the secondary circuit in the storage tank raising the temperature T₄ of the inlet water to the outlet water T₅;
establish a continuous flow of cooled coolant at temperature T₃ leaving the inner chamber and entering the outer chamber of the primary coolant circuit.

2. The solar water heater panel of claim 1 wherein the partition wall of the middle housing further comprises:
one or more first holes that run between the outer and inner surfaces of the partition wall of the middle housing and arranged towards a first end of the panel, each of one or more first valves being fixed in each of the first holes and configured to allow the primary fluid to pass only from the outer chamber to the inner one; and
one or more second holes extending between the outer and inner surfaces of the separating wall of the plastic middle housing and disposed towards a second end of the panel, each of one or more second valves being secured in each of the one or more second holes and configured to allow the primary fluid to pass only from the inner chamber to the outer chamber;
whereby, the solar panel, when it is sufficiently inclined to place the first end above the second end, is configured so that: when the glass sheet is subjected to sufficient solar radiation: the one or more first and one or more second valves are opened by thermo-siphon action to establish by convection the continuous flow of heated coolant; and when the glass sheet is not subjected to sufficient solar radiation: the first and second valves remain closed to prevent the flow of coolant between the outer and inner chambers of the primary circuit.

3. The solar water heater panel of claim 1, further comprising:
a pump connection with the inner and outer chambers of the continuous primary coolant circuit, the pump being powered by a photovoltaic cell and configured to pump coolant; from the outer to the inner chamber at the first end above the second end of the panel;
at least one hole at the second end in the partition wall between the inner and outer chambers configured to allow coolant to pass from the inner to the outer chamber, but not from the outer to the inner chamber;
pump, photovoltaic cell and primary fluid being configured such that the coolant in the outer chamber is hotter than the coolant in the inner chamber, the pump is activated and the continuous flow of heated coolant between outer and inner chambers established.

4. The solar water heater panel of claim 2, the middle housing further comprising:
a plurality of buttress extending from the inner surface of the partition wall of the middle-housing and abutting the primary circuit surface of the metal sheet;
the plurality of buttress being configured to abut the primary circuit surface of the metal sheet opposite locations on the secondary circuit surface of the metal sheet abutted by the plurality of base-housing walls,
whereby the metal sheet is secured by the plurality of abutting buttress and the plurality of base-housing walls.

5. The solar water heater panel of claim 4, wherein the storage tank is divided by walls into a plurality of channels connected fluidly in series: the longitudinal axes of each of the plurality of channels are aligned substantially perpendicular to the axis of the panel extending between the first and second ends of the panel, configured so that the walls of the plurality of channels close the passage to the flow of water allowing it to only advance in a path from one side to the other until finding the exit through the outlet fitting;
whereby base housing walls give stiffness to solar water panel and also ensures the metal sheet to coincide on the other side with the buttresses of the middle housing and allow the water rise by convection when the secondary water circuit storage tank is full with water and hot.

6. The solar water heater panel of claim 2, wherein the glass and metal sheets and plastic-middle and base housings are secured using a plurality of clips and/or adhesive.

7. The solar water heater panel of claim 6, further comprising one or more mounting anchorages suitable for attaching the panel to an inclined or flat surface.

8. The solar water heater panel of claim 2, wherein the outer partition wall surface of the middle housing comprises a material for absorbing solar radiation.

9. The solar water heating panel of claim 2, further comprising a second glass sheet comprising upper and lower surfaces, the second lower surface of glass sheet disposed opposite the upper surface of the first glass sheet for enclose a space between the first and second sheets and provide additional thermal insulation between the external chamber of the coolant.

10. The solar water heater panel of claim 2, further comprising a storage tank top disposed at the water circulation end of the secondary circuit and configured to cover a portion of the exposed part of the secondary circuit surface of the metal sheet adjacent to the hot water outlet fitting.

11. The solar water heater panel of claim 2, further comprising a frame abutting the perimeter of the top surface of the glass sheet.

12. The solar water heater panel of two circuits of fluids of low volatility wherein is composed by two main parts, the solar collector and the storage tank solar panel sharing a metal sheet all together. The solar collector is former by top frame, glasses, middle housing with valves and filling/expansion tank with components and metal sheet as heat exchanger. The storage tank is former by base housing, inlet and outlet fitting, storage tank top and sharing metal sheet with the solar collector.

13. The solar water heater panel of claim land 12, wherein middle and/or base housing is composed of expanded polystyrene foam, obstructed polystyrene or syndiotactic polystyrene and the metal sheet is composed of aluminum, copper or stainless steel.
